(19) United States
(12) Patent Application Publication
(10) Pub. No.: US 2003/0086227 A1
(43) Pub. Date: May 8, 2003

(54) Device for protecting a power component against voltage surges

(75) Inventors: Jean-Yves Coiret, de la Moisson (FR); Thierry Refalo, La Serre (FR)

Correspondence Address: SUGHRUE MION, PLLC, 2100 Pennsylvania Avenue, N.W., Washington, DC, 20037-3213, US

(73) Assignee: ALSTOM

(21) Appl. No.: 10/277,157

(22) Filed: Oct. 22, 2002

(30) Foreign Application Priority Data
Nov. 5, 2001 (FR) 01 14 271

(51) Int. Cl. H02H 3/20

(52) U.S. Cl. 361/91.5

(57) ABSTRACT

A device for protecting against voltage surges a power semiconductor component having a collector, an emitter and a gate, the device including a protection circuit connected in parallel between the collector and the gate. The protection circuit has a main branch including at least two Zener diodes connected in series and a secondary branch including a capacitor and connected in parallel with at least one of the Zener diodes of the main branch. The protection circuit also has an additional branch including a resistor which is connected in parallel with the capacitor.

### BACKGROUND OF THE INVENTION

1. Field of the Invention

The invention relates to a device for protecting power semiconductor components against voltage surges. The invention finds an application in rail power converters, for example.

2. Description of the Prior Art

At present most power converters for powering rail traction motors use IGBT. FIG. 1 is a diagram showing one arm of a converter of this kind and shows that the converter arm consists of a first IGBT 4 having a collector C to which an external potential +HV is applied and an emitter E which is connected to a traction motor 10 and a second IGBT 4 having a collector C connected to the traction motor 10 and an emitter E to which a potential −HV is applied. Each IGBT 4 has a gate G connected to a control circuit, not shown.

In normal operation of the above kind of converter the IGBT 4 is switched in the manner shown in FIG. 2, which represents the voltage V_{CE} between the collector C and the emitter E of the IGBT 4 as a function of time.

In this figure, between times t₀ and t₁, the IGBT is turned off and a line voltage V_{L} is applied to the terminals of the IGBT. At time t₁, the IGBT is turned on and the voltage across it falls substantially to zero. At time t₂, the IGBT is turned off and the voltage V_{CE} across it then rises very quickly, causing a voltage surge Vₚₑₐₖ. A voltage Vₚₑₐₖ greater than the maximum permitted voltage of the IGBT destroys it and therefore causes the power converter to fail.

Protecting the IGBT of power converters against voltage surges by connecting a protection circuit like that shown in FIG. 3 between the collector C and the gate G of the IGBT 4 shown in FIG. 1 is known in the art. The prior art protection circuit shown in FIG. 3 has a main branch 1 including n+N Zener diodes Z₁ to Z_{n+N} connected in series; the cathode of each Zener diode faces toward the collector C of the IGBT. The main branch 1 further includes a resistor 6 and a protection diode 7 connected in series with the n+N Zener diodes previously described, the protection diode 7 being connected in the reverse direction compared to the Zener diodes Z₁ to Z_{n+N}.

The protection circuit also includes a secondary branch 2 consisting of a capacitor 5 connected in parallel with the N Zener diodes Zₙ₊₁ to Z_{n+N} of the main branch 1.

This kind of protection circuit, which peak limits the voltage, has a static conduction threshold V_{static} and a dynamic conduction threshold V_{dynamic} satisfying the following equations, assuming that the Zener diodes Z₁ to Z_{n+N} of the main branch 1 have identical characteristics:

V_{static}=(n+N)×Vz

where Vz is the voltage threshold applied to the terminals of a Zener diode of the main branch from which the Zener diode conducts, and:

V_{dynamic}=n×Vz

this dynamic threshold being obtained because of the capacitor connected in parallel with the N Zener diodes Zₙ₊₁ to Z_{n+N}, which short circuits the diodes in the event of fast changes of state of the IGBT to which the protection circuit is connected.

The threshold V_{static} is chosen to suit the rating of the IGBT and is generally greater than the maximum line voltage V_{L} of the converter arm in normal operation.

The threshold V_{dynamic} is chosen to suit the rating of the IGBT and can in some cases be less than the maximum line voltage of the arm in normal operation.

The above kind of protection circuit solves the problems of voltage surges in the IGBT under normal circumstances. Because the potential at the gate G of an IGBT 4 is close to the potential at its emitter E, any sudden variation in the voltage between the emitter E and the collector C of the IGBT 4 appears at the terminals of the protection circuit connected between the collector C and the gate G. With this kind of protection circuit, if the voltage V_{CE} reaches the threshold V_{dynamic} after the IGBT 4 is turned off at time t₂, the n Zener diodes Z₁ to Zₙ begin to conduct and shunt a current that flows through the capacitor 5, shunting the N Zener diodes Zₙ₊₁ to Z_{n+N}, the capacitor 5 being initially discharged during the period in which the IGBT 4 is turned on. This current is re-injected into the gate G of the IGBT 4, which slows down its change of state and therefore limits the voltage surge at its terminals.

We have nevertheless realized that, although it protects the IGBT effectively in normal operation, the above kind of protection circuit has the drawback of being ineffective in combating voltage surges when the IGBT is desaturated. The IGBT is desaturated when it is turned on and is conducting a current equal to about six to seven times the nominal current; this can be caused by a fault in the load to which it is connected, for example, or by short circuiting the arm.

In this case, although the IGBT is turned on, the voltage at its terminals quickly becomes equal to the line voltage V_{L}, as shown in FIG. 4. The IGBT then dissipates a very high instantaneous power which can very quickly destroy it. In this kind of situation it is therefore urgent to open the switch consisting of the IGBT and to attempt to limit the voltage surge.

However, because desaturation is accompanied by a high voltage at the terminals of the IGBT, the capacitor 5 of the prior art protection circuit is in a charged state up to the time t₂ at which the IGBT is turned off, and no longer provides its anticipation role because it no longer allows a current to flow above the dynamic threshold V_{dynamic} of the protection circuit. The protection circuit then peak limits the voltage at the terminals of the IGBT only from a higher threshold V_{static}, which can be fatal for the IGBT, because the voltage surge is only very slightly reduced, and this can cause the converter to fail.

Also, an object of the present invention is to propose a voltage surge protection circuit that is simple and economic to produce and is effective even if the power semiconductor is desaturated.

### SUMMARY OF THE INVENTION

To this end, the invention provides a device for protecting against voltage surges a power semiconductor component having a collector, an emitter and a gate, the device including a protection circuit connected in parallel between the collector and the gate, and the protection circuit having a main branch including at least two Zener diodes connected in series, a secondary branch including a capacitor and connected in parallel with at least one of the Zener diodes of the main branch, and an additional branch including a resistor which is connected in parallel with the capacitor.

Specific embodiments of the device according to the invention can have any of the following features, either alone or in any technically feasible combination:

the resistor is connected directly to the terminals of the capacitor;

the main branch of the protection circuit includes a succession of Zener diodes connected in series and some of which are shunted by the secondary branch including the capacitor; and

the power semiconductor component is an IGBT.

The invention also relates to a power converter for a rail vehicle, which converter includes at least one power semiconductor component including a voltage surge protection device according to the invention.

Objects, aspects and advantages of the present invention will be understood better from the description of one particular embodiment of the invention given hereinafter by way of non-limiting example and with reference to the accompanying drawings.

### BRIEF DESCRIPTION OF THE DRAWINGS

FIGS. 1 to 4, which have already been commented on, show a power converter arm, the operation of the IGBT in that kind of arm and a voltage surge protection device, all in accordance with the prior art.

FIG. 5 shows a voltage surge protection device according to the invention, connected between the collector and the gate of an IGBT of the converter arm from FIG. 1, not shown in this figure.

### DETAILED DESCRIPTION OF THE PREFERRED EMBODIMENT

To clarify the drawings, only the components necessary for an understanding of the invention have been shown. The same components carry the same reference numbers from one figure to another.

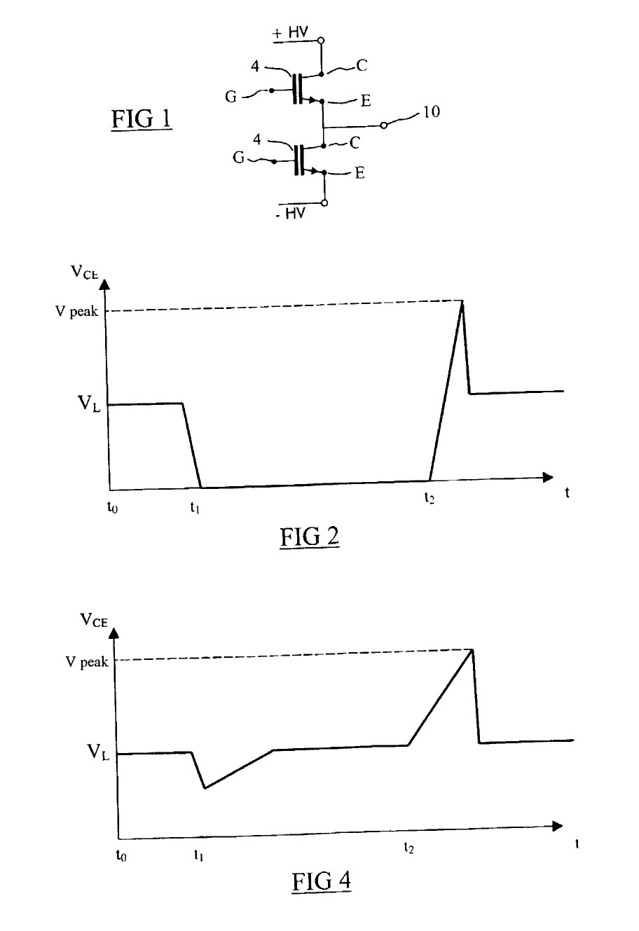

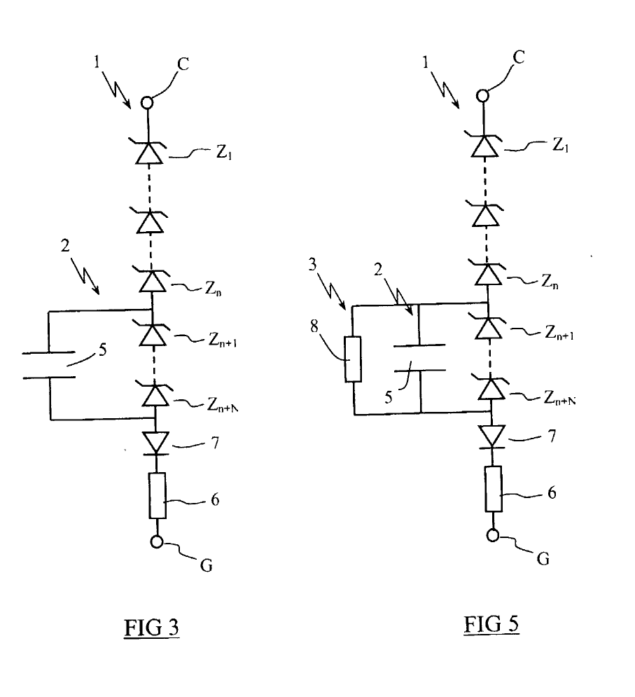

FIG. 5 shows a voltage surge protection device according to the invention which remedies the drawbacks of the prior art and which is intended to be connected between the collector C and the gate G of each IGBT 4 shown in FIG. 1.

In the particular embodiment of the invention shown in FIG. 5, the protection device consists of a protection circuit including a main branch 1 and a secondary branch 2 similar to those of the prior art circuit shown in FIG. 3.

According to an essential feature of the invention, the protection circuit further includes an additional branch 3 consisting of a resistor 8 connected in parallel with the capacitor 5 in the secondary branch 2.

This kind of protection device has the advantage of a dynamic threshold such that it remains responsive when the IGBT 4 is desaturated. The resistor 8 shunts a very low current which is added to the leakage currents of the N Zener diodes Zₙ to Z_{n+N} connected in parallel, which discharges the capacitor 5 during the phase in which the IGBT 4 is desaturated. Thus, when the IGBT 4 is desaturated, the capacitor 5 is not charged at all or only weakly charged just before the IGBT 4 is turned off. The protection circuit is then active as soon as the voltage V_{CE} reaches the threshold V_{dynamic}, which reduces the voltage surge at the IGBT 4 in the same way as in normal operation of the arm. Tests with a DC line voltage of 900 V using a protection circuit having a static threshold V_{static} set to 1 200 V and a dynamic threshold V_{dynamic} set to 900 V have shown that this reduces the voltage surge in the FIG. 5 device by more than 32% compared to the prior art device.

Of course, the invention is in no way limited to the embodiment described and shown, which has been described and shown merely by way of example, and can be modified without departing from the scope of the protection afforded to the invention, in particular with regard to the composition of the various components or by substituting technical equivalents.

There is claimed:

1. A device for protecting against voltage surges a power semiconductor component having a collector, an emitter and a gate, said device including a protection circuit connected in parallel between said collector and said gate, and said protection circuit having a main branch including at least two Zener diodes connected in series, a secondary branch including a capacitor and connected in parallel with at least one of said Zener diodes of said main branch, and an additional branch including a resistor which is connected in parallel with said capacitor.

2. The device claimed in claim 1 for protecting a power semiconductor component against voltage surges, wherein said resistor is connected directly to the terminals of said capacitor.

3. The voltage surge protection device claimed in claim 1, wherein said main branch of said protection circuit includes a succession of Zener diodes connected in series and some of which are shunted by said secondary branch including said capacitor.

4. The voltage surge protection device claimed in claim 1, wherein said power semiconductor component is an IGBT.

5. The power converter for a rail vehicle, which converter includes at least one power semiconductor component including a voltage surge protection device as claimed in any of claims 1 to 4.
